(19) United States
(12) Patent Application Publication
(10) Pub. No.: US 2026/0056014 A1
(43) Pub. Date: Feb. 26, 2026

(54) METHOD AND APPARATUS FOR IN-SITU SAMPLE QUALITY INSPECTION IN CRYOGENIC FOCUSED ION BEAM MILLING

(71) Applicant: TECHNISCHE UNIVERSITEIT DELFT, Delft (NL)

(72) Inventors: Jacob Pieter HOOGENBOOM, Delft (NL); Radim SKOUPÝ, Delft (NL); Daan Benjamin BOLTJE, Delft (NL); Arjen-Joachim JAKOBI, Delft (NL)

(21) Appl. No.: 19/099,505

(22) PCT Filed: Jul. 21, 2023
(86) PCT No.: PCT/NL2023/050393

§ 371 Date: Jan. 29, 2025

(30) Foreign Application Priority Data
Jul. 29, 2022 (NL) 2032641

(51) Int. Cl. G01B 15/02; G01N 23/06

(52) U.S. Cl. CPC G01B 15/025; G01N 23/06

(57) ABSTRACT

A method and a dual beam FIB/(S)TEM apparatus are provided for in-situ sample quality inspection in cryogenic focused ion beam milling. The method comprises the steps of: loading the sample into a sample holder of the dual beam FIB/(S)TEM apparatus, wherein the (S)TEM apparatus comprises an electron column and a detector, wherein the sample holder is arranged in between the electron column and the detector; obtaining an image of the electrons that have passed through the sample using the electron column to direct an electron beam towards the sample and using the detector to detect electrons passing through the sample; and using a scattering pattern in the image of the transmitted electrons to establish a measure for the thickness of the sample and to establish whether or not the image comprises a diffraction signal due to electron diffraction from ice crystals.

### BACKGROUND

The invention relates to a method and apparatus for in-situ assessing the quality of samples for use in a Transmission Electron Microscope (TEM), and in particular samples which are produced by cryogenic focused ion beam milling for to be studied by electron cryo-tomography.

Electron Cryo-Tomography (ECT) is a unique technique for structural biology and its application in e.g. pharmaceutical research as it allows to retrieve biological macromolecular structures at almost atomic resolution. Information at this level is crucial to determine how macromolecules such as proteins and viruses interact during health and disease and how we can intervene in these interactions in order to identify strategies to cure disease. As samples for ECT are kept at cryogenic temperature during imaging, the native biological state can be preserved provided the sample is rapidly cooled (or fixated) into an amorphous, vitrified state.

A challenge arises from the requirement of samples for ECT to be very thin (<1 μm). This is because contrast in ECT is obtained from phase differences in the exit wave of elastically scattered electrons induced by variations in sample composition. Inelastic electron scattering has to be circumvented, which means samples typically need to be thinner than the mean free path for inelastic scattering. In practice, sample thicknesses between 100-200 nm are preferred, and thinner is often better. An additional reason to aim for thinner samples is that for thinner samples, a lower electron beam energy may be used, mitigating sample damage and thereby allowing to extract more information at higher resolution from the sample. Relevant biological materials however are mostly not sufficiently thin. Cryogenic Focused Ion Beam (FIB) milling provides a solution to this problem as the focused ion beam allows to mill away material with a high spatial accuracy (˜10 nm) without affecting the unexposed material. This way, a thin slice or lamella can be cut out of a cryo-fixed biological material after which (part of) this lamella can be imaged in a TEM to obtain a three-dimensional reconstruction at almost atomic resolution using ECT.

US 2010/0116977, for example, describes a method for TEM sample creation. The use of a Scanning Electron Microscope (SEM) or Scanning Transmission Electron Microscope (STEM) detector in a dual-beam FIB/SEM allows a sample to be thinned using the FIB, while the SEM signal is used to monitor sample thickness. A preferred embodiment can measure the thickness of or create STEM samples by using a precise endpoint detection method that is reproducible and is suitable for automatic ‘endpointing’ during lamella creation. It further provides users with direct feedback on sample thickness during manual thinning.

In addition to the sample thickness, it is also desired to have a region of interest inside the lamella. A problem with cryo-FIB milling of biological materials is, that this is a ‘blind’ process meaning that biological materials do not provide contrast in FIB or SEM to reveal compositional differences. It may be very difficult to mill a lamella at exactly the right position and depth in the target material, e.g. such that a particular biological structure, macromolecular complex, or virus is contained in the lamella. In addition, it is also impossible to assess whether the sample is vitrified at the position of milling, which is however crucial as ice formation leads to electron scattering and may also redistribute or affect integrity of biological material. Finally, it is difficult to precisely establish the thickness of the lamella during milling, which, as explained above, may be key to obtaining the best results.

A potential solution to the first problem (finding the regions of interest for FIB milling) may be found by correlating the FIB-milling to previously obtained fluorescence microscope (FM) data obtained from the same cryo-fixed sample. To improve throughput and prevent sample contamination or (partial) devitrification during sample transfer, the FM may also be integrated within the FIB-SEM to allow inspection in vacuum, as for example disclosed in WO 2022/190136. To allow for highly accurate milling of structures within single cells or organelles, FM and cryo-FIB-SEM may even be combined such that all three beams (photons, ions, and electrons) are coincident. In this configuration, FM and SEM can be conducted with the sample in the right position for FIB-milling.

### SUMMARY OF THE INVENTION

A disadvantage of the known methods and devices is, that they only relate to one aspect in the creation of thin lamellas. The inventors have realized that the quality of a lamella for use in ECT is in a combination of sample properties. In particular for biological samples for ECT analysis, the amorphous, vitrified state should be maintained at least until the ECT analysis has been completed.

It is an object of the present invention to provide a solution of the above disadvantage by assessing lamella quality for ECT at least in terms of lamella thickness and incomplete vitrification.

According to a first aspect, the invention pertains to a method for in-situ sample quality inspection in cryogenic focused ion beam milling in a dual beam FIB and (S)TEM apparatus, wherein the method comprises the steps of:
loading the sample into a sample holder of the dual beam FIB/(S)TEM apparatus, wherein the (S)TEM apparatus comprises an electron column and a detector, wherein the sample holder is arranged in between the electron column and the detector;
obtaining an image of the transmitted electrons using the electron column to direct an electron beam towards the sample and using the detector to detect electrons that have passed through the sample;
using a scattering pattern in said image of the transmitted electrons to establish a measure for the thickness of the sample and to establish whether or not the image comprises a diffraction signal due to electron diffraction.

Scattering of the transmitted electrons is highly dependent on sample thickness and based on this fact, several ways can be used to determine the thickness of the sample, in particular of the lamella, as described in more detail in various embodiments below.

As indicated above, the native biological state can be preserved provided that the sample is rapidly cooled (or fixated) into an amorphous, vitrified state. The samples for ECT are kept at a cryogenic temperature during the handling of the samples, lamella creation and imaging of the sample using ECT. Native state preservation is highly important for the interpretation and use of ECT results. When the amorphous vitrified state is not preserved, for example when the amorphous vitrified state in the sample is at least locally changed by the formation of ice crystals, this may indicate that also the native state is not preserved. In addition, this will lead to additional changes in the image due to electron diffraction at said ice crystals, which may deteriorate later ECT results. Accordingly, potential changes in the image due to electron diffraction at ice crystals is used to evaluate whether or not the sample is still in the desired amorphous vitrified state. When an image comprises an additional diffraction pattern due to electron diffraction at ice crystals, the native state is likely to be no longer present in the specific sample, and such a sample is considered to be of low quality and may be discarded for use in ECT.

It is noted, that the method is performed in a dual-beam FIB/(S)TEM, which allows a sample to be thinned using the FIB, while the (S)TEM is used to monitor sample thickness and changes in the image due to diffraction from ice crystals. Accordingly, the method allows for in-situ sample quality inspection. Preferably, the electron beam of the (S)TEM and the ion beam of the FIB can be operated at the same time or intermittently.

It is further noted that the term ‘(S)TEM’ as used herein refers to a TEM (Transmission Electron Microscope) or a STEM (Scanning Transmission Electron Microscope).

In an embodiment, the diffraction pattern is due to electron diffraction from ice crystals, and wherein the diffraction pattern is further evaluated to establish whether or not cubic and/or hexagonal ice crystals are present in the sample. Since the crystal structure of cubic ice crystals and hexagonal ice crystals are different, also their diffraction pattern produced by these different crystal forms are different, which allows to distinguish between the different crystal forms, when present. The presence of one or more forms of crystal ice in a sample may provide clues about the reason for incomplete vitrification. For example, the presence of hexagonal ice may be an indication for improper and slow kinetics during freezing of the sample.

A first embodiment to determine the thickness of the sample, in particular of the lamella, uses the electron loss due to an interaction between the electron beam and the sample to establish the measure for the thickness of the sample. The thicker the sample, the larger the electron loss of the electron beam that is transmitted through the sample. Since there is a monotone relation between the thickness of the sample and the electron loss, the electron signal of the transmitted beam can provide a measure for the thickness of the sample; the higher the electron signal from the detector, the thinner the sample.

In an embodiment, the electron loss is determined by comparing the intensity of the beam transmitted through the sample and the intensity of the beam without a sample present, and/or wherein one or more standard samples with a known thickness is used to obtain a relation between the amount of electron loss and the thickness of the sample.

In an embodiment, the method is used for samples with a thickness in a range from 0 to 100 nm.

A second embodiment to determine the thickness of the sample, in particular of the lamella, uses an analysis of the scattering pattern to determine a measure for the most probable scattering angle, and wherein said most probable scattering angle is used to establish the measure for the thickness of the sample. When the intensity of the scattered electron beam is determined as a function of the scattering angle, a peak in intensity is found at the most probable scattering angle. This most probable scattering angle shifts to higher angles for thicker samples. Since this second method determines just the scattering angle where the peak in the intensity is located, this method is independent of the intensity of the electron beam and does not require prior sensor calibration.

In an embodiment, one or more standard samples with a known thickness is used to obtain a relation between the most probable scattering angle and the thickness of the sample.

In an alternative embodiment, the measured most probable scattering angle is compared to the results of a Monte Carlo simulation of electron scattering, preferably as stored in a look-up table, which provides a relation between the most probable scattering angle and the thickness of the sample.

In an embodiment, the method is used for samples with a thickness in a range from 75 to 500 nm.

A third embodiment to determine the thickness of the sample, in particular of the lamella, uses an analysis of the scattering pattern to obtain a signal for non-scattered electrons to provide a bright field signal, and to obtain a signal for scattered electrons to provide a dark field signal, wherein a ratio between the bright field signal and the dark field signal is used to establish the measure for the thickness of the sample. An advantage of using this relative ratio is, that absolute levels of the signals are not required. It is noted that the bright field signal has a monotone relation with the sample thickness (comparable to the first embodiment to determine the thickness of the sample as discussed above). However the dark field signal has no monotone relation with the sample thickness; the dark field signal will increase with thinner samples, however for very thin samples there is less and less material that can scatter the electrons and for such very thin samples, the dark field signal will decrease with sample thickness. Accordingly, the ratio (bright field signal)/(dark field signal) increases with a decreasing thickness of very thin samples.

In an embodiment, one or more standard samples with a known thickness is used to obtain a relation between the ratio of (bright field signal)/(dark field signal) and the thickness of the sample.

In an embodiment, the method is used for samples with a thickness in a range from 50 to 700 nm.

In an embodiment, the dual beam FIB/(S)TEM apparatus is configured for using at least two of the following methods to determine the sample thickness:
i. using the electron loss due to an interaction between the electron beam and the sample according to the first embodiment as described above;
ii. using the most probable scattering angle according to the second embodiment as described above;
iii. using the ratio between the bright field signal and the dark field signal according to the third embodiment as described above;
   wherein the method comprises the step of switching between said at least two of the methods to determine the sample thickness during the fabrication of a lamella.

Since each of the methods has a thickness regime where it is most accurate, this embodiment allows to switch between methods for determining the thickness of the sample in order to use the most accurate method.

It is noted that all three methods i, ii, iii of the embodiment use signals from electrons which have passed through the sample. In an embodiment, the same detector is used for detecting electrons transmitted through the sample in the at least two of the methods i, ii, iii to determine the sample thickness, and preferably in all three methods i, ii, iii to determine the sample thickness, wherein the step of switching between said at least two of the methods i, ii, iii to determine the sample thickness is provided by switching between different methods for analyzing the measurements from the detector. Accordingly, the switching between the different methods i, ii, iii to determine the sample thickness is actually performed in a controller and/or a data analyzing device of the dual beam FIB/(S)TEM apparatus. This allows for an easy and/or automatic switching between the at least two of the methods i, ii, iii to determine the sample thickness.

In an embodiment, the electron energy of the electron beam from the electron column is 30 keV. However, preferably, the energy of the electron beam from the electron column is optimized for determination of the thickness in a specific thickness range. The inventors found that the accuracy at a specific thickness may depend on the electron energy.

Basically, the thickness determination methods as described above, are spot measurements. However they can easily turned into mapping when spots are composed in a matrix of measurement points. Thus the thickness determination methods can be conducted on an area on the lamella under preparation. The thickness determination method can even be conducting at positions on the sample where there is not a region of interest present, thus preventing unwanted electron beam damage of the region of interest. This may reduce beam damage and the risk of devitrification of the sample at least at the region of interest to a minimum.

In an embodiment, the method is carried out on multiple positions on the sample in order to obtain a measure for the homogeneity of the thickness of the sample or lamella.

In an embodiment, the detector comprises a scintillator and an optical detector, wherein the scintillator is arranged spaced apart from a sample on the sample holder and in between the sample holder and the optical detector, wherein the method comprises the steps of:
converting the electrons that have passed through the sample into photons using the scintillator; and
projecting and/or imaging the photons from the scintillator onto the optical detector.

Accordingly, the transmitted electrons and the scattering/diffraction pattern is converted into a corresponding distribution of photons, which distribution is imaged onto the optical detector, such as a CCD image detector. Thus the light image as obtained by the optical detector also comprises the scattering/diffraction pattern which was originally present in the transmitted electrons.

In an embodiment, the dual beam FIB/(S)TEM apparatus comprises a light optical microscope, which is used for collecting and imaging the photons from the scintillator onto the optical detector. By providing an integrated light optical microscope, this light optical microscope may also be used to provide a light-based estimation of the thickness of the lamella, e.g. by using reflection patterns from the front-and backside of the lamella. Preferably a first thickness of the sample is estimated using light optical measurements so as to prevent sample exposure with the electron beam. When the anticipated thickness is reached, a more accurate thickness determination and/or an assessment of the amorphous state can be carried out using the (S)TEM detection methods as described above.

In an embodiment, the scintillator is arranged with respect to the sample in the sample holder that both the sample and the scintillator are within a focus range of the objective lens of the optics that collect the light and images it onto the optical detector. This allows on the one hand to study the sample with the light optical microscope, and on the other hand to obtain an image of the scintillator. In an embodiment, the sample holder is configured to provide a distance between the scintillator and the sample of 300 micrometers.

According to a second aspect, the invention pertains to a dual beam FIB/(S)TEM apparatus for micromachining a sample, wherein the apparatus comprises an integral combination of:
a sample holder for holding the sample;
a FIB unit for projecting a focused ion beam onto the sample held by the sample holder for micromachining said sample;
a (S)TEM unit comprising an electron column and a detector, wherein the sample holder is arranged in between the electron column and the detector in order to detect electrons from the electron column that have passed through the sample;
a controller which is configured for controlling the apparatus to perform, in use, the steps of the method or an embodiment thereof as described above.

The various aspects and features described and shown in the specification can be applied, individually, wherever possible. These individual aspects, in particular the aspects and features described in the attached dependent claims, can be made subject of divisional patent applications.

### BRIEF DESCRIPTION OF THE DRAWINGS

The invention will be elucidated on the basis of an exemplary embodiment shown in the attached drawings, in which:

FIG. 1 schematically shows a first exemplary embodiment of an apparatus for performing the method of the present invention;

FIG. 2 schematically shows a second exemplary embodiment of an apparatus for performing the method of the present invention;

FIG. 3 schematically shows the principle of electron to light conversion used for (S)TEM detection;

FIG. 4 schematically shows the principle of sample thickness estimation using the most common scattering angle;

FIG. 5 schematically shows a scattering pattern of a transmitted electron beam through a sample in an amorphous vitrified state; and

FIG. 6 schematically shows a scattering/diffraction pattern of a transmitted electron beam through a sample with incomplete vitrification.

### DETAILED DESCRIPTION OF THE INVENTION

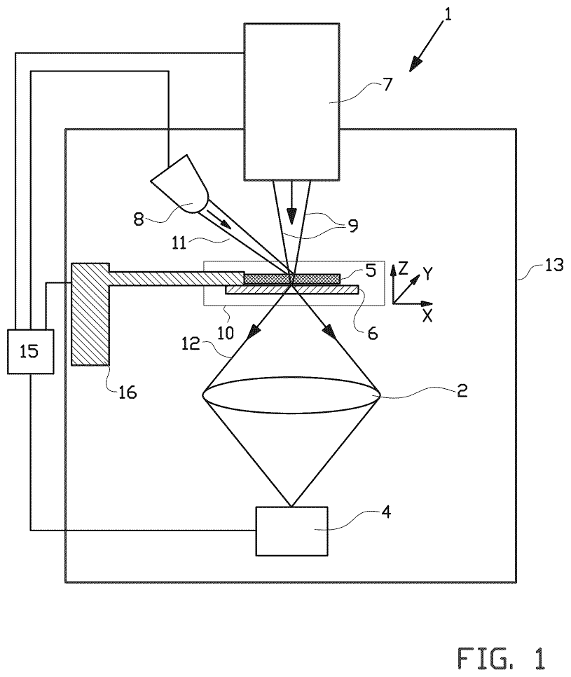

FIG. 1 schematically shows a first exemplary embodiment of an apparatus for performing the method of the present invention. The apparatus comprises in combination at least a Focused Ion Beam (FIB) unit 8 and a (Scanning) Transmission Electron Microscope (S)TEM 7, 2, 4. The FIB 8 is configured for focusing an ion beam 11 onto a sample 5 on a sample holder 10 and the (S)TEM is configured for focusing an electron beam 9 onto the sample 5 on the sample holder 10.

The (S)TEM comprises an electron column 7 for emitting a primary electron beam 9 and directing said primary beam to a sample 5 supported by a substrate 6 (for example a TEM mesh grid) included in a sample holder 10. The (S)TEM comprises electron optics 2 for projecting the electrons 12 transmitted through the sample 5 onto a detector 4. Both the FIB and the (S)TEM are substantially arranged inside a vacuum chamber 13.

The inspection apparatus 1 comprises a sample holder 10 for holding the sample 5. The sample holder 10 comprises a cooling system 16 which is configured for cooling the sample 5. Cooling systems as such are known in the art, for example from WO 2020/190136 A1. However, other cooling systems can also be applied in order to maintain the amorphous vitrified state of the sample 5.

The apparatus of FIG. 1 is provided with a controller 15, e.g. in the form of a computer, including a personal computer, wherein said controller 43 is provided with dedicated software which is configured for implementing one or more methods of the invention or an embodiment thereof as described in the description above.

As schematically indicated in FIG. 1, the sample holder comprises a stage for moving the sample 5 with respect to the FIB 8 and/or the (S)TEM 7, 2, 4. Preferably the stage is configured for providing six degrees of freedom for moving the sample 5; thus providing translational movement along the X, Y and Z axis and rotational movement around the X, Y and Z axis.

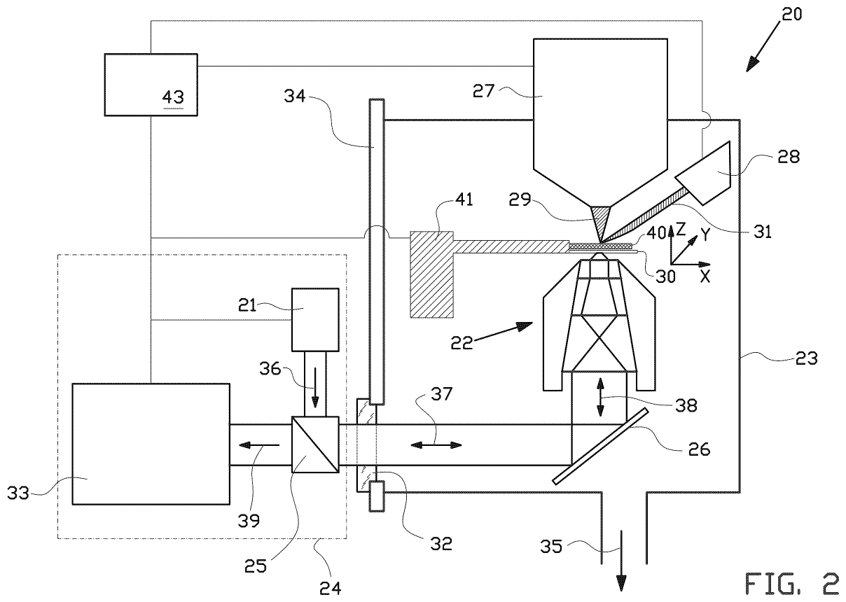

FIG. 2 schematically shows a second exemplary embodiment of an apparatus for performing the method of the present invention. The apparatus 20 of FIG. 2 comprises a Scanning Electron Microscope (SEM) 27 comprising a vacuum chamber 23 which is connected to a vacuum pump via a connector 35. Inside said vacuum chamber 23, a sample 40 is arranged, which sample 40 can be irradiated with an electron beam 29. The apparatus 20 comprises a FIB unit 28 for generating, directing and focussing an ion beam 31 onto the sample 40.

As schematically shown, a sheet of scintillating material 30 is arranged at a side of the sample 40 facing away from the SEM 27, wherein the sheet of scintillating material 30 is spaced apart from the sample by a preferred (but not limited to) a distance of 300 micrometer. The sample holder comprises a cooling system 41 which is configured for cooling the sample 40 and the sheet of scintillating material 30. Again, cooling systems as such are known in the art, for example from WO 2020/190136 A1. However, other cooling systems can also be applied, in order to ensure that the amorphous vitrified state of the sample 40 is maintained.

The sheet of scintillator material 30, for example comprising a thin slab of YSO:Ce or LYSO:Ce,Ca which have a transparency window form 400 nm and higher. Preferably the sheet of scintillator material 30 is provided with a thin layer of transparent conductive material, preferably indium tin oxide (ITO), to avoid charging of the upper surface of the sheet of scintillator material, which would otherwise give rise to beam deflection and pattern distortion. The sample holder is configured to position the sample 40 in between the SEM 27 and the sheet of the scintillator material 30.

Below the sheet of scintillating material 30 a microscope objective 22 is arranged inside the vacuum chamber 23, which is part of the light optical microscope system. In this particular example, the other major parts of the light optical microscope system are arranged outside the vacuum chamber 23 in an illumination and detection box 24.

The illumination and detection box 24 may comprise a light source 21, for example a LED of a Laser. The emitted light 36 from het light source 21 is directed out of the illumination and detection box 24 via a half transparent mirror or dichroic mirror 25 and is directed into the vacuum chamber 23 via a window 32. This light 37, 38 is coupled into the microscope objective 22 via a mirror 26, for illuminating the sample 40. Although the illumination arrangement can be used for illuminating the sample with light and to study the sample under illumination by light, the illumination arrangement is not necessary to obtain an image using the transmitted electrons through the sample 40 which are converted into light by the sheet of scintillating material 30.

Light 37, 38 from the sample 40 is collected by the microscope objective 22 and is directed via the mirror 26 and the window 32 towards the illumination and detection box 24, and is imaged 39 via the half transparent mirror or dichroic mirror 25 onto a camera 33, for example a CCD detector.

As shown in FIG. 2, the light beams for illuminating and/or imaging the sample 40 enters into and passed from the vacuum chamber 23 via a window 32 which in this example is arranged in a door 34 of said vacuum chamber 23. The illumination and detection box 24 of the light optical microscope system is arranged outside vacuum chamber 23 and may be attached to the outside of the door 34. However, the illumination and detection part of the light optical microscope system may as well be included fully inside, e.g. attached to a bottom part, of the vacuum chamber 23.

In this exemplary embodiment, it is advantageous to select a sheet of scintillator material 30 which is at least substantially transparent, preferably wherein the sheet of scintillator material is substantially transparent for light in a wavelength range in the visual spectrum. Accordingly, the sample 40 can be observed by means of the light optical microscope through the sheet of scintillator material 30. Preferably the sheet of scintillator material 30 is transparent at the excitation and emission bands of fluorescent markers which may be used for localizing regions of interest.

As schematically indicated in FIG. 2, the sample holder comprises a stage for moving the sample 40 for providing six degrees of freedom in movement of the sample 40; thus providing translational movement along the X, Y and Z axis and rotational movement around the X, Y and Z axis.

The apparatus of FIG. 2 is provided with a controller 43, e.g. in the form of a computer, including a personal computer, wherein said controller 43 is provided with dedicated software which is configured for implementing one or more methods of the invention or an embodiment thereof as described in the description above.

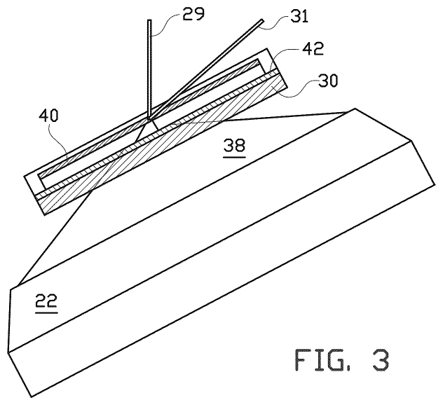

FIG. 3 schematically shows an example of the sample holder for use in the apparatus of FIG. 2, in more detail. The sample 40 is arranged at a position where both the primary electron beam 29 and the focused ion beam 31 are directed to. The electrons that pass through the sample spread out due to the scattering of the electrons in the sample. The broadened beam 44 impinges on the scintillator 30, which is arranged spaced apart from the sample 40 in particular to allow a desired amount of broadening in order to be able to detect the scattering pattern.

As schematically shown in FIG. 3, the side of the scintillator 30 facing the sample 40 is provided with an ITO layer 42. The light 38 from the scintillator is collected by the microscope objective 22.

Regarding the methods to determine the thickness of the sample, it is noted that the first embodiment of using the electron loss as a function of the sample thickness is very straight forward and does not need any further explanation.

In addition, with regard to the third embodiment it is noted that it is known in art to obtain the bright field signal and the dark field signal. Reference is made, for example, to WO2010/0116977 A1 which is incorporated herein by reference.

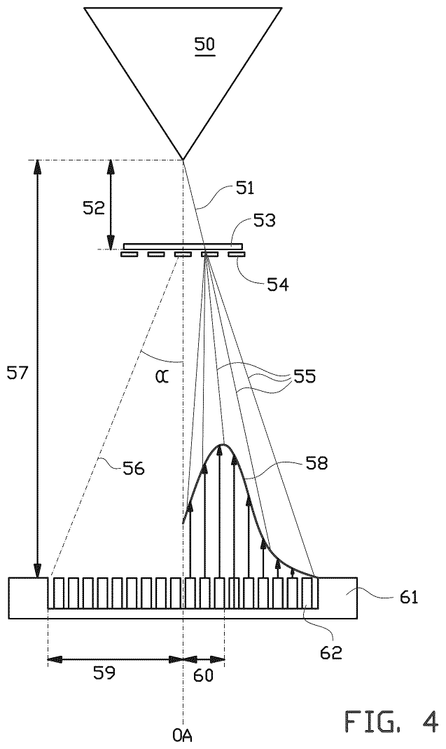

Regarding the second embodiment, the principle of the sample thickness estimation method using angular shift of the most probable scattering angle, is presented schematically in FIG. 4. The pole piece 50 is configured for emitting a primary electron beam 51 onto a sample 53, which is arranged at a working distance 52 from the pole piece 50. The sample 53 is arranged on top of a TEM mesh grid 54. In the openings of the TEM mesh grid 54, the transmitted part of the primary electron beam 51 may emerge, wherein the primary electron beam 51 is at least partially scattered by the material of the sample 53, resulting in scattered beams 55. The scattered beams 55 impinge on a detector 61 with a detector size 59, which detector 61 is arranged at a pole piece to detector distance 57. The graph in FIG. 4 represents a summarized annulus signal 58, which has clearly a peak at position 60 at an scattering angle which constitutes the most probable scattering angle. This peak position 60 shifts to lower angles with decreasing sample thickness.

In order to find a measure for the sample thickness, the measured most probable scattering angle 60 is compared to the results of a Monte Carlo simulation of electron scattering, preferably as stored in a look-up table, which provides a relation between the most probable scattering angle 60 and the thickness of the sample 53.

In order to establish whether or not the amorphous vitrification of the sample is still intact, one can search for traces of a diffraction pattern in the image.

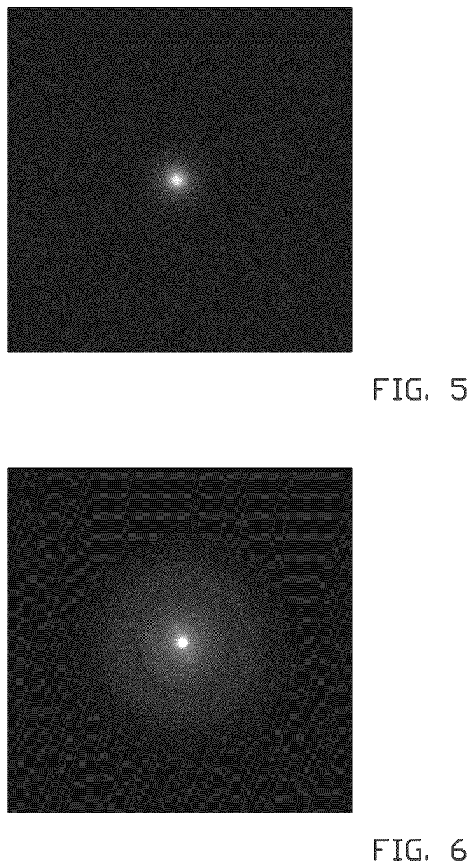

FIG. 5 schematically shows a scattering pattern of a transmitted electron beam through a first sample. Since there is no diffraction pattern is present in this image, it can be concluded that the first sample is in an amorphous vitrified state.

FIG. 6 schematically shows a scattering pattern of a transmitted electron beam through a second sample. Around the central spot of scattered electrons, several point-like features are visible, which originate from the diffraction of electrons at the ice crystals in the second sample. Since there is a diffraction pattern is present in this image, it can be concluded that the second sample has at least locally an incomplete vitrification.

The absence of point-like features in FIG. 5 indicates that the sample of FIG. 5 is substantially amorphous, and most likely still intact and preserved in the native state.

It is to be understood that the above description is included to illustrate the operation of the preferred embodiments and is not meant to limit the scope of the invention. From the above discussion, many variations will be apparent to one skilled in the art that would yet be encompassed by the scope of the present invention.

1-16. (canceled)

17. A method for in-situ sample quality inspection in cryogenic focused ion beam milling in a dual beam FIB/(S)TEM apparatus, the method comprising the steps of:
loading the sample into a sample holder of the dual beam FIB/(S)TEM apparatus, wherein the (S)TEM apparatus comprises an electron column and a detector, wherein the sample holder is arranged in between the electron column and the detector;
obtaining an image of the electrons that have passed through the sample using the electron column to direct an electron beam towards the sample and using the detector to detect electrons passing through the sample;
using a scattering pattern in said image of the transmitted electrons to establish a measure for the thickness of the sample and to establish whether or not the image comprises a diffraction signal due to electron diffraction.

18. The method according to claim 17, wherein the diffraction pattern is due to electron diffraction from ice crystals, and
wherein the diffraction pattern is further evaluated to establish whether or not cubic and/or hexagonal ice crystals are present in the sample.

19. The method according to claim 17, wherein the electron loss due to an interaction between the electron beam and the sample is used to establish the measure for the thickness of the sample.

20. The method according to claim 19, wherein the electron loss is determined by comparing the intensity of the beam transmitted through the sample and the intensity of the beam without a sample present, and/or
wherein one or more standard samples with a known thickness is used to obtain a relation between the amount of electron loss and the thickness of the sample.

21. The method according to claim 19, wherein the method is used for sample with a thickness in a range from 0 to 100 nm.

22. The method according to claim 17, wherein the scattering pattern is analyzed to determine a measure for the most probable scattering angle, and
wherein said most probable scattering angle is used to establish the measure for the thickness of the sample.

23. The method according to claim 22, wherein one or more standard samples with a known thickness is used to obtain a relation between the most probable scattering angle and the thickness of the sample.

24. The method according to claim 22, wherein the measured most probable scattering angle is compared to the results of a Monte Carlo simulation of electron scattering, preferably as stored in a look-up table, which provides a relation between the most probable scattering angle and the thickness of the sample.

25. The method according to claim 22, wherein the method is used for sample with a thickness in a range from 75 to 500 nm.

26. The method according to claim 17, wherein the scattering pattern is analyzed to obtain a signal for non-scattered electrons to provide a bright field signal, and to obtain a signal for scattered electrons to provide a dark field signal,
wherein a ratio between the bright field signal and the dark field signal is used to establish the measure for the thickness of the sample.

27. The method according to claim 26, wherein the method is used for sample with a thickness in a range from 50 to 700 nm.

28. The method according to claim 17, further comprising the dual beam FIB/(S)TEM apparatus performing at least two of the following steps to determine the sample thickness:
i. using the electron loss due to an interaction between the electron beam and the sample, wherein the electron loss due to an interaction between the electron beam and the sample is used to establish the measure for the thickness of the sample;
ii. using the most probable scattering angle, wherein the scattering pattern is analyzed to determine a measure for the most probable scattering angle, and wherein said most probable scattering angle is used to establish the measure for the thickness of the sample;
iii. using the ratio between the bright field signal and the dark field signal, wherein the scattering pattern is analyzed to obtain a signal for non-scattered electrons to provide a bright field signal, and to obtain a signal for scattered electrons to provide a dark field signal, wherein a ratio between the bright field signal and the dark field signal is used to establish the measure for the thickness of the sample;
wherein the method further comprises the step of switching between said at least two of the steps (i), (ii), and (iii) to determine the sample thickness during the fabrication of a lamella.

29. The method according to claim 28, wherein the same detector is used for detecting electrons transmitted through the sample in the at least two of steps (i), (ii), and (iii) to determine the sample thickness,
wherein the step of switching between said at least two of steps (i), (ii), and (iii) to determine the sample thickness is provided by switching between different methods for analyzing measurements from the detector.

30. The method according to claim 28, wherein the same detector is used for detecting electrons transmitted through the sample in all three of the steps (i), (ii), and (iii) to determine the sample thickness,
wherein the step of switching between said all three of the steps (i), (ii), and (iii) to determine the sample thickness is provided by switching between different methods for analyzing measurements from the detector.

31. The method according to claim 17, wherein the method is carried out on multiple positions on the sample in order to obtain a measure for the homogeneity of the thickness.

32. The method according to claim 17, wherein the detector comprises a scintillator and an optical detector,
wherein the scintillator is arranged spaced apart from a sample on the sample holder and in between the sample holder and the optical detector,
wherein the method further comprises the steps of:
converting the electrons that have passed through the sample into photons using the scintillator; and
projecting and/or imaging the photons from the scintillator onto the optical detector.

33. A dual beam FIB/(S)TEM apparatus for micromachining a sample, wherein the apparatus comprises an integral combination of:
a sample holder for holding the sample;
a FIB unit for projecting a focused ion beam onto the sample held by the sample holder for micromachining said sample;
a (S)TEM unit comprising an electron column and a detector, wherein the sample holder is arranged in between the electron column and the detector in order to detect electrons from the electron column that have passed through the sample;
a controller which is configured for controlling the apparatus to perform the steps of the method according to claim 17.
